(19) United States
(12) Patent Application Publication
(10) Pub. No.: US 2009/0145846 A1
(43) Pub. Date: Jun. 11, 2009

(54) FLUIDIZED BED APPARATUS AND METHOD FOR REMOVING SOLUBLE AND PARTICULATE MATTER FROM A LIQUID

(76) Inventors: Donald E. Burns, DePere, WI (US); Bradley K. Hansen, Holladay, UT (US)

Correspondence Address: HUSCH BLACKWELL SANDERS LLP, 4801 Main Street, Suite 1000, KANSAS CITY, MO, 64112, US

(21) Appl. No.: 11/951,877

(22) Filed: Dec. 6, 2007

(51) Int. Cl. B01D 24/36; B01D 15/02; B01D 24/38; B01D 35/30; B01D 35/143; B01D 24/00

(52) U.S. Cl. 210/661; 210/109; 210/265; 210/289; 210/86

(57) ABSTRACT

An apparatus and method for removing soluble and particulate matter from a liquid. The liquid is introduced into a lower section of the apparatus and develops an upward helical flow. The vertical component of the helical flow is decreased in a conical section. The liquid then passes through fluidized bed media where an interaction between the liquid and the fluidized bed media can occur. The liquid may be passed through a system that removes suspended solids.

### CROSS-REFERENCE TO RELATED APPLICATIONS

None.

### BACKGROUND OF THE INVENTION

In the treatment of water, it is known in the industry to use conical sludge blanket clarifiers (CSBC) for clarification and cold lime softening applications. CSBCs incorporate a cylindrical inlet flow device located at the bottom of an inverted conical vessel. Liquid enters the cylindrical inlet flow device at multiple tangential inlet ports which creates an upward helical liquid flow pattern. In its typical operation, a CSBC contains a sludge blanket of suspended solids within the inverted conical vessel.

It is also known in the industry to use fluidized bed biological reactors (FBBR) containing sand media to treat wastewater. FBBRs containing sand media having a high specific surface area per unit volume of media (M²/m³) which provides for high biomass concentrations, hence high biological loadings. FBBRs have influent distribution systems which must achieve uniform distribution of influent liquid flow across the entire reactor area, prevent plugging and media escape, minimize abrasive wear, and minimize shearing of biomass above the influent distribution manifold. Typical influent distribution systems include a header manifold, lateral pipes branching from the header manifold, and nozzles attached to the lateral pipes pointing down towards the bottom of the reactor. The liquid flow pattern within FBBRs is primarily vertical from the influent distribution systems to the overflow collectors.

It is also known in the industry to use fluidized bed chemical reactors (FBCR) to remove calcium compounds, such as calcium carbonate, from low magnesium raw waters. FBCRs typically have inverted conical configurations with very steep sidewalls. The fluidized bed media used in FBCRs often consists of fine sand. FBCRs have tangential inlet ports which creates an upward helical liquid flow pattern.

CSBCs do not provide an ion exchange process, which can further purify and decontaminate liquids. With fluidized bed reactors, any suspended solids contained in the inlet liquid and any suspended solids generated within the reactor will be contained in the outlet liquid. Typically, the suspended solids must be removed in a separate process that follows the fluidized bed reactor. In fluidized bed reactors utilizing ion exchange, high concentrations of non-target ions will often be discharged in the outlet liquid as the fluidized bed becomes saturated with the target ions.

Accordingly, a need exists for an apparatus and method that can remove suspended solids as well as effecting a fluidized bed media. A need also exists for a fluidized bed reactor that allows for the reduction of non-target ion concentration spikes. A further need exists for a fluidized bed reactor that has enhanced reaction kinetics, which leads to shorter detention times, smaller vessels, and lower costs.

### SUMMARY OF THE INVENTION

The present invention is directed to a fluidized bed apparatus that provides removal of various contaminants using fluidized bed media in addition to the removal of suspended solids. In accordance with one embodiment of the invention, a fluidized bed reactor includes a lower section effecting a rotational flow component, a generally conical middle section, an upper section containing fluidized bed media, and optionally a means for removing particular matter. A tangential inlet port preferably feeds, liquid into the lower section to assist in developing an upward helical liquid flow pattern in the middle section. The Fluidized bed media may be used to perform an ion exchange process or a variety of other processes for removing contaminants.

The present invention is also directed to a method of removing soluble and particulate matter from a liquid including the steps of introducing a liquid into a first vessel in a manner creating an upward helical flow of the liquid, discharging the liquid from the first vessel in a generally conical second vessel that overlies the first vessel therefore causing a decrease in the vertical velocity component of the generally helical flow as the liquid moves up through the second vessel, and passing the liquid generally upward through a fluidized bed media that is located above the second vessel and formulated to remove selected contaminants from the liquid.

### DESCRIPTION OF THE SEVERAL VIEWS OF THE DRAWINGS

In the accompanying drawings:

FIG. 1 is a cross-sectional elevational view of the fluid bed apparatus containing a vertical velocity component means for removing particulate matter and a flow collection system in accordance with one embodiment of the present invention;

FIG. 2 is a cross-sectional elevational view of the fluid bed apparatus containing a flow collection system in accordance with one embodiment of the present invention;

FIG. 3 is a cross-sectional elevational view of the fluid bed apparatus containing a means for removing particulate matter utilizing a gravity sedimentation device and a flow collection system in accordance with one embodiment of the present invention;

FIG. 4 is a cross-sectional elevational view of the fluid bed apparatus containing a means for removing particulate matter utilizing a buoyant granular media filter and a flow collection system in accordance with one embodiment of the present invention; and

FIG. 5 is a cross-sectional elevational view of the fluid bed apparatus containing a means for removing particulate matter utilizing a submerged membrane filtration device in accordance with one embodiment of the present invention.

### DESCRIPTION OF THE PREFERRED EMBODIMENTS

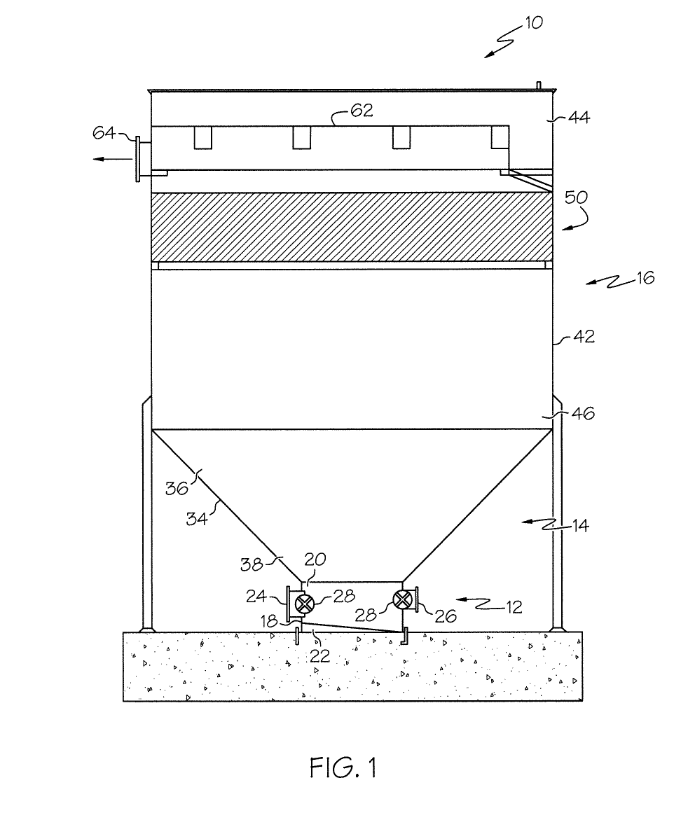

The present invention is directed toward a fluidized bed reactor 10 and method for removing soluble and particulate matter from a liquid. As shown in FIG. 1, a fluidized bed reactor 10 constructed according to one embodiment of the invention includes a lower section 12, a middle section 14, and an upper section 16.

The lower section 12 includes a wall 18, an upper end 20, and a lower end 22. In one embodiment, the lower section wall 18 is generally cylindrical. However, it will be appreciated by those skilled in the art that the lower section wall 18 can alternatively be constructed in other geometries, including a generally conical configuration. Tangential inlet ports 24, 26 allow untreated liquid to be fed into the lower section 12. As illustrated in FIGS. 1-5, one inlet port 24 may be larger than another inlet port 26. However, it will be appreciated by those skilled in the art that the inlet ports 24, 26 may also be the same size. While two tangential inlet ports 24, 26 are shown in FIGS. 1-5, the present invention could include a single inlet port 24 or more than two inlet ports 24, 26.

The inlet ports 24, 26 are positioned tangential to the inner surface of the lower section wall 18. A tangential positioning of the inlet ports 24, 26 in the lower section 12, along with the removal of liquid from the upper section 16, serves to develop an upward helical flow of the liquid in the lower section 12 and the middle section 14. The helical flow may also continue into the upper section 16. The helical flow results in the liquid traveling in an elongated flow path.

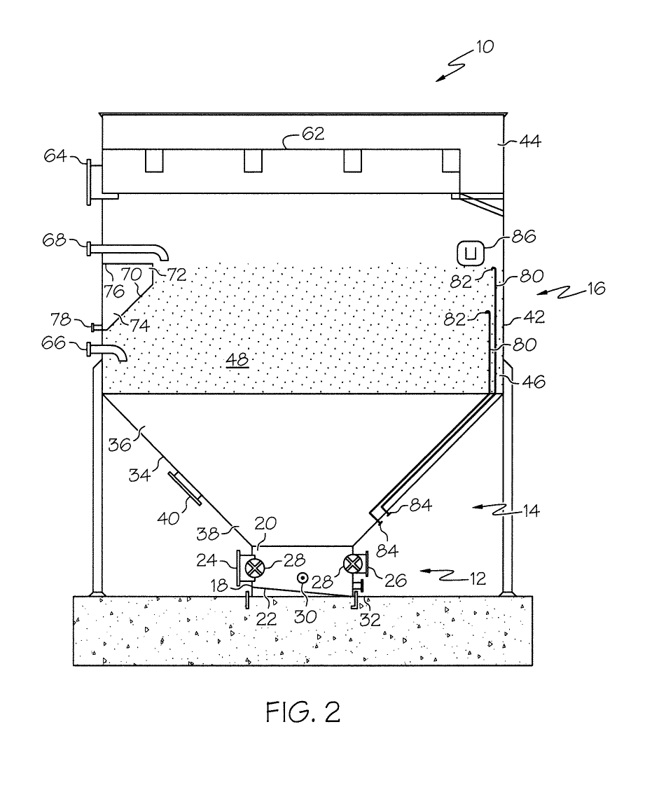

Flow directing vanes 28 may be provided to be in communication with the inlet ports 24, 26. The flow directing vanes 28 can be adjusted to vary the inlet velocity of liquid into the lower section 12. As illustrated in FIGS. 2-5, the lower section 12 may also include an inlet service nozzle 30. The inlet service nozzle 30, which is capable of producing a high velocity liquid flow, can be used to assist the inlet ports 24, 26 in re-suspending the fluidized bed media 48 should the fluidized bed media 48 settle into the lower section 12. Also, as illustrated in FIGS. 2-5, the lower section 12 may include an outlet port 32 proximate its lower end 22 that can be used to remove heavy grit.

The middle section 14 includes a wall 34, an upper end 36, and a lower end 38. In one embodiment, the middle section wall 34 is generally conical and extends upwardly and outwardly from the lower section upper end 20 to the upper section lower end 46. The primary function of the middle section 14 is to reduce the vertical velocity vector of the upward helical liquid flow. As the liquid rises in its upward helical path through the generally conical middle section 14, it spreads to fill the increasing cross-sectional area of the middle section 14. This results in a corresponding decrease in the vertical velocity vector of the liquid traveling through the middle section 14, while the net flow rate of the liquid through the middle section 14, as well as the net flow rate of the liquid through the entire reactor 10, remains constant.

The vertical velocity of the liquid continues to decrease until it reaches a portion of the reactor 10 having a constant cross-sectional area. Proximate the upper section lower end 46, the vertical velocity of the liquid is generally equal to the velocity required to keep the fluidized bed media 48 in section 16 suspended. In other words, the lifting force of the liquid and the counteracting gravitational force on the fluidized bed media 48 are in equilibrium. The vertical velocity that is required to keep the fluidized bed media 48 suspended is a function of multiple factors, including the density, shape, and size of the fluidized bed media 48, as well as the temperature, density, and viscosity of the liquid being treated.

In one embodiment, the middle section wall 34 is inclined at an angle of 40 to 60 degrees from the horizontal to provide for the proper rate of decrease in the vertical velocity of the liquid and to prevent the fluidized bed media from settling and accumulating on the wall 34. Depending upon the vertical velocity of the liquid, there can be fluidized bed media 48 contained in the middle section 14, as well as the upper section 16. As shown in FIGS. 2-5, the middle section 14 may also include an access plate 40 through which the reactor 10 can be inspected, maintained, and cleaned.

The upper section 16 includes a wall 42, an upper end 44, and a lower end 46. In one embodiment, the upper section wall 42 is generally cylindrical. However, it will be appreciated by those skilled in the art that the upper section wall 42 can alternatively be constructed in other geometries, including square, rectangular, or generally conical configurations. When the upper section wall 42 is generally conical, or configured in any other geometry having an increasing cross-sectional area, the vertical velocity of the liquid traveling through the upper section 16 will continue to decrease until it reaches a point where the cross-sectional area of the of the upper section 16 is no longer increasing and becomes constant.

As illustrated in FIGS. 2-5, the upper section contains fluidized bed media 48. The fluidized bed media 48 may be used to perform an ion exchange process. The fluidized bed media 48 may remove soluble ions, molecules, and/or other compounds from the liquid through biological, physical, or chemical processes. The material of the fluidized bed media 48 may be selected from a group consisting of granular activated carbon, ion exchange resin, sand, combinations thereof, or any other material suitable for use in the present invention now known or hereafter developed. As previously discussed, the fluidized bed media 48 is suspended in the upper section 16 (and in some cases the middle section 14 as well) by the lifting force of the liquid, which counteracts the gravitational force on the fluidized bed media 48.

It is desirable to have the ability to replace, regenerate, and/or rejuvenate the fluidized bed media 48 while the reactor 10 is in use. In order to replace, regenerate, and/or rejuvenate the fluidized bed media 48, the reactor must include a means for removing fluidized bed media and a means for adding fluidized bed media. As shown in FIGS. 2-5, the upper section 16 may contain a fluidized bed media outlet port 66 and 68 and a fluidized bed media inlet port 68 and 66. These ports 66, 68 may be located between the upper section upper and lower ends 44, 46. The upper section 16 may also contain a submerged hopper 70 having an upper end 72, a lower end 74, an overflow dam 76 proximate the upper end 72, and a fluidized bed media outlet port 78 proximate the lower end 74. The submerged hopper 70 provides a location where the fluidized bed media 48 can consolidate prior to removal from the reactor 10. The overflow dam 76 is located at a height equal to the maximum desirable upper level of the fluidized bed media 48. The level of the fluidized bed media 48 can be continuously monitored by a level sensor 86.

One of the events triggering removal of fluidized bed media 48 from the reactor 10 occurs when the fluidized bed media 48 reaches a level above its maximum desirable upper level. Again, the overflow dam 76 is located at a height equal to the maximum desirable upper level of the fluidized bed media 48. Once the fluidized bed media 48 reaches a level above the overflow dam 76, the fluidized bed media 48 can enter the region directly above the hopper 70. In this region directly above the hopper 70, the vertical velocity of the liquid is decreased due to the hopper 70 deflecting the upward flow of the liquid. This decrease in vertical velocity results in the liquid having a vertical velocity less than that required to keep the fluidized bed media 48 suspended. In other words, in the region directly above the hopper 70, the lifting force of the liquid is less than the counteracting gravitational force on the fluidized bed media 48. Therefore, the fluidized bed media 48 descends into the hopper 70. Once the fluidized bed media 48 is in the hopper 70, it can be removed through the hopper's outlet port 78.

As illustrated in FIGS. 2-5, the reactor 10 can also contain sample lines 80. The sample lines 80 have inlet ports 82 and outlet ports 84. The sample lines 80 are used to obtain samples of fluidized bed media 48. While two sample lines 80 are shown in FIGS. 2-5, the present invention could include a single sample line 80 or more than two sample lines 80. If the reactor 10 contains two or more sample lines 80, the sample line inlet ports 82 can be located at multiple elevations within the fluidized bed media 48, as shown in FIGS. 2-5. The sample line outlet ports 84 are located outside of the middle section 14 near ground level for access by a user.

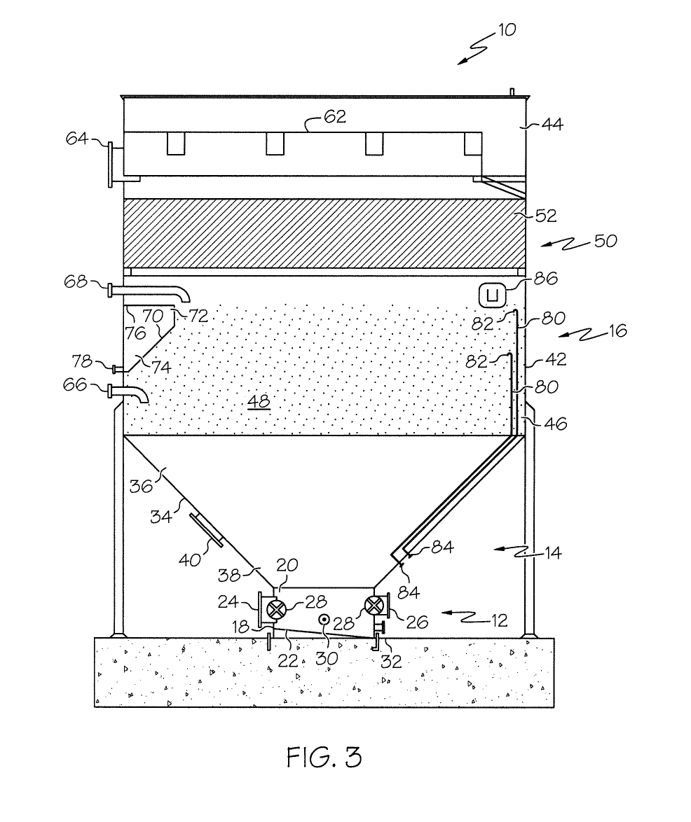

The upper section 16 can also include a means 50 for removing particulate matter, such as suspended solids, from the liquid. As shown in FIG. 3, the means 50 for removing particulate matter 50 can be a gravity sedimentation device 52. The gravity sedimentation device 52 can include tube settlers. The tube settlers can be positioned parallel to each other and at an incline between 30 and 60 degrees from horizontal. For applications requiring the use of expensive fluidized bed media 48, tube settlers can be used to minimize the loss of the fluidized bed media 48. In an alternative embodiment, the gravity sedimentation device 52 can make use of multiple flat sheets that are positioned parallel to each other at an incline between zero and 60 degrees from horizontal.

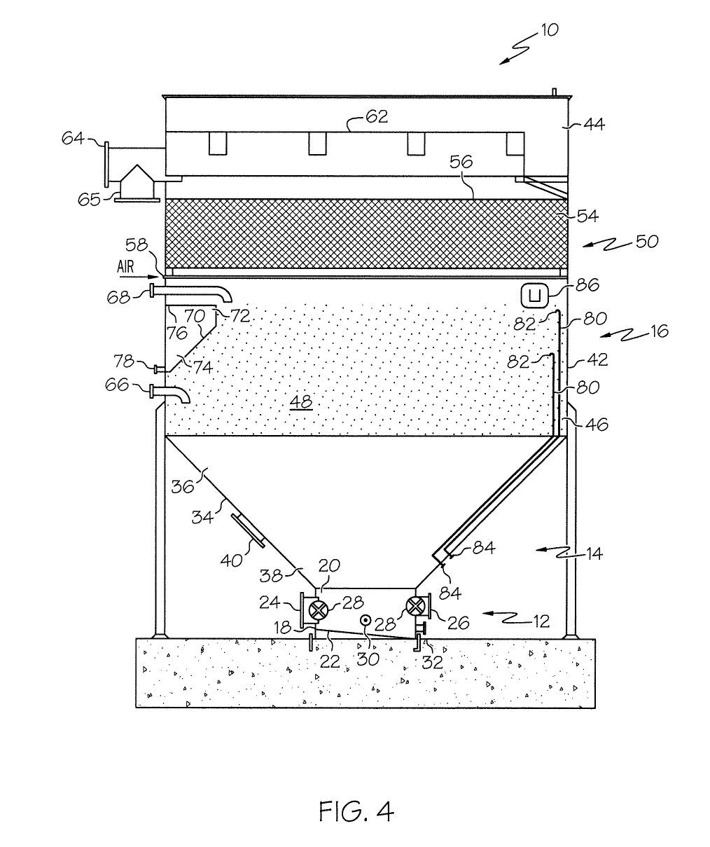

As shown in FIG. 4, the means for removing particulate matter 50 can include a buoyant granular media filter 54. The buoyant granular media has a specific gravity less than the specific gravity of the liquid in the reactor 10. The material of the buoyant granular media may be selected from a group consisting of polyethylene, polystyrene, polypropylene, pumice, combinations thereof, or any other material suitable for use in the present invention now known or hereafter developed. When a buoyant granular media filter 54 is used, the buoyant granular media is retained by an overlying retaining screen 56. The retaining screen 56 should have openings smaller than the nominal size of the buoyant granular media.

The buoyant granular media 54 may require occasional backwashing. The backwashing is accomplished by diverting outlet flow from the primary outlet 64 to a secondary outlet 65 and adding air uniformly through an air distribution grid 58 located beneath the granular media filter 54.

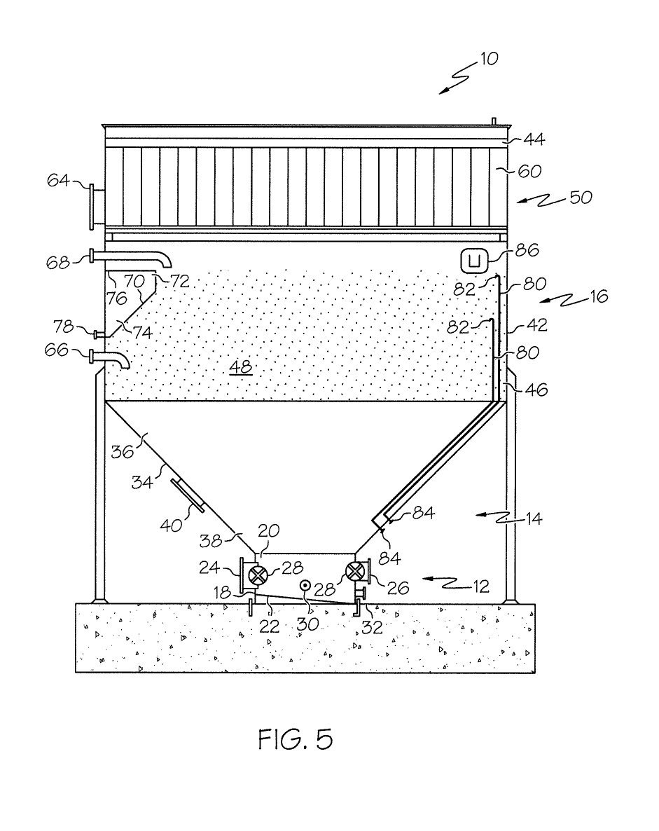

As shown in FIG. 5, the means for removing particulate matter 50 can include a submerged membrane filtration device 60. The submerged membrane filtration device 60 allows liquid to pass through it but retains particulate matter from passing. The submerged membranes may include hollow fibers having diameters less than ¼ inch. Both ends of the hollow fibers may be connected to the filtration device 60 such that the treated liquid can be collected and passed from the filtration device 60 through the outlet 64. The submerged membrane filtration device 60 can also include a submerged membrane that is configured in a flat sheet arrangement with a void between two sheets where the clarified liquid can be collected and passed from the filtration device 60 through the outlet 64.

The reactor 10 can also include a flow collection system 62 (FIGS. 1-4) proximate the upper section upper end 44. The flow collection system 62 may collect the liquid passing through the reactor and direct it to a common collection point outside of the reactor 10. The flow collection system 62 can include a plurality of radial troughs, a plurality of parallel troughs, or a manifold header with a plurality of lateral troughs.

Several treatment processes can be achieved within the fluidized bed reactor 10 of the present invention, including biological processes, ion exchange processes, physical adsorption processes, and chemical precipitation processes. The biological processes can include the anoxic de-nitrification of waters containing nitrates. The ion exchange processes can include the ion exchange of soluble ions, molecules, or compounds on synthetic or natural ion exchange media. For example, one ion exchange process involves the removal of disinfection by-product precursors from waters. The physical adsorption processes can include the physical adsorption of soluble ions, molecules, or compounds on the surface of adsorbents. For example, one physical adsorption process involves the removal of soluble organic contaminates upon activated carbons. The chemical precipitation processes can include the chemical precipitation upon inert media. For example, one chemical precipitation process involves cold lime softening for the removal of calcium such as calcium carbonate.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

We claim:

1. A fluidized bed reactor, comprising:
a lower section including a tangential inlet for feeding a liquid into said lower section in a manner to effect an upward generally helical flow of the liquid in said lower section;
a generally conical middle section including an upper end and a lower end receiving the liquid from said lower section, said middle section having an increasing diameter from said lower end toward said upper end to effect a decrease in the vertical component of the generally helical flowing liquid in said middle section;
an upper section receiving the liquid from said middle section and containing a fluidized bed media for treating the liquid; and
an outlet from said upper section for removing treated liquid therefrom.

2. The fluidized bed reactor of claim 1, wherein said lower section is generally cylindrical in shape.

3. The fluidized bed reactor of claim 1, further comprising a flow directing vane in communication with said tangential inlet.

4. The fluidized bed reactor of claim 1, further comprising an outlet port proximate a lower end of said lower section.

5. The fluidized bed reactor of claim 1, further comprising a nozzle on said lower section for resuspending fluidized bed media settled in said lower section.

6. The fluidized bed reactor of claim 1, wherein the upward velocity of the liquid in said middle section decreases to become generally equal to the settling rate of said fluidized bed media.

7. The fluidized bed reactor of claim 1, further comprising an access plate coupled to said generally conical middle section.

8. The fluidized bed reactor of claim 1, further comprising a flow collection system for collecting the liquid passing through said reactor and directing the liquid outside of said reactor.

9. The fluidized bed reactor of claim 8, wherein said flow collection system comprises a plurality of troughs.

10. The fluidized bed reactor of claim 8, wherein said flow collection system comprises a collector launder to a plurality of lateral troughs.

11. The fluidized bed reactor of claim 1 further comprising means for removing particulate matter from the liquid located in said upper section.

12. The fluidized bed reactor of claim 11, wherein said means for removing particulate matter includes a gravity sedimentation device.

13. The fluidized bed reactor of claim 11, wherein said means for removing particulate matter includes a buoyant granular media filter.

14. The fluidized bed reactor of claim 11, wherein said means for removing particulate matter includes a membrane filtration device.

15. The fluidized bed reactor of claim 1 wherein said fluidized bed media is formulated to effect an ion exchange, physical adsorption, biological, disinfection, and/or chemical reaction process between said fluidized bed media and said liquid.

16. The fluidized bed reactor of claim 1 further comprising means for removing said fluidized bed media from said upper section and means for adding said fluidized bed media to said upper section.

17. The fluidized bed reactor of claim 16, wherein said removing means includes a fluidized bed media outlet port on said upper section and said adding means includes a fluidized bed media inlet port on said upper section.

18. The fluidized bed reactor of claim 16, wherein said removing means includes a hopper having an upper end and a lower end, an overflow dam located proximate said hopper upper end, and a fluidized bed media outlet port located proximate said hopper lower end, and wherein said adding means includes a fluidized bed media inlet port.

19. The fluidized bed reactor of claim 1, further comprising at least one sample line having an inlet port and an outlet port, wherein said inlet port is located within said upper section and said outlet port is located outside of said generally conical middle section.

20. The fluidized bed reactor of claim 1, further comprising a level sensor for monitoring the level of said fluidized bed media.

21. A fluidized bed reactor for treating liquid, comprising:
a lower section having an inlet for receiving the liquid in a manner effecting a flow pattern therein having a rotational component;
a center section having a generally conical shape with a lower end arranged to receive liquid from said lower section and an upper end having a greater diameter than said lower end to effect a generally helical flow in said center section, with a vertical component of said generally helical flow decreasing from said lower end toward said upper end;
an upper section arranged to receive liquid from said upper end of said center section, said upper section containing a fluidized bed media formulated to remove selected contaminants from the liquid; and
an outlet from said upper section for discharging the liquid therefrom.

22. A method of treating liquid, comprising the steps of:
introducing the liquid into a first vessel in a manner effecting a flow pattern therein having a rotational component;
discharging the liquid from said first vessel into a generally conical second vessel overlying said first vessel and increasing in diameter from bottom to top such that a generally helical flow is effected in said second vessel wherein a decreasing vertical component of said generally helical flow is effected from bottom to top in said second vessel; and
passing the liquid generally upward through a fluidized bed media located above said second vessel and formulated to remove selected contaminants from the liquid.

23. The method of claim 22 including removing and replenishing fluidized bed media.

24. The method of claim 22 including monitoring the level of said fluidized bed media.

25. The method of claim 22 including sampling said fluidized bed media.
